(19) United States
(12) Patent Application Publication
(10) Pub. No.: US 2017/0099675 A1
(43) Pub. Date: Apr. 6, 2017

(54) METHOD FOR TRANSMITTING DATA PACKETS SWITCHED BETWEEN A RANDOM ACCESS CHANNEL (RACH) AND A DEMAND ASSIGNED MULTIPLE ACCESS (DAMA) CHANNEL

(71) Applicant: THALES, COURBEVOIE (FR)

(72) Inventors: Mathieu GINESTE, TOULOUSE (FR); David NIDDAM, TOULOUSE (FR); Cécile FAURE, TOULOUSE (FR); Isabelle ULPAT, TOULOUSE (FR)

(21) Appl. No.: 15/270,999

(22) Filed: Sep. 20, 2016

(30) Foreign Application Priority Data
Oct. 2, 2015 (FR) 1502051

(51) Int. Cl. H04W 72/12; H04W 74/08

(52) U.S. Cl. CPC H04W 72/1263; H04W 74/0833

(57) ABSTRACT

A method for transmitting data over an uplink from a terminal TE taken out of a plurality of terminals to a gateway GW switches data packets or packet fragments between a first random access mode and a second demand assigned multiple access DAMA mode. Each terminal TE routes the data packets or the packet fragments over the random access channel RACH or over a demand assigned multiple access channel via a demand assigned multiple access DAMA according to the size of the packets and their class of service, and information items representative of the current transmission resources allocated to the random access channel RACH and to the demand assigned multiple access DAMA mode, the representative information items being notified to the terminals via a return link.

### CROSS-REFERENCE TO RELATED APPLICATION

This application claims priority to foreign French patent application No. FR 1502051, filed on Oct. 2, 2015, the disclosure of which is incorporated by reference in its entirety.

### FIELD OF THE INVENTION

The present invention relates to an optimized method for transmitting data packets or packet fragments switched between a slotted random access channel RACH and a demand assigned multiple access DAMA channel.

The present invention relates also to a transmission system, configured to implement an optimized method for transmitting data packets or packet fragments, switched between a random access channel RACH and a demand assigned multiple access DAMA channel.

The present invention relates also to a user terminal, incorporated in said transmission system, and configured to transmit data packets or packet fragments switched according to said transmission method.

The invention relates also to a computer program comprising instructions which, when they are loaded on computers of the transmission system, execute the optimized transmission method.

### BACKGROUND

Generally, the invention is applicable to any communication system requiring a random access transmission channel on an uplink whose traffic is sporadic, dense and unpredictable, and that can use, for example, bent-pipe or regenerative satellites and/or terrestrial wireless connections, even cable connections.

Various random access methods are known, including the conventional asynchronous ALOHA protocol, the derivative ALOHA protocol with time-division or slotted segmentation (slotted ALOHA) and its derivatives combining the capture effect CE and/or the effect of use of a diversity (time or frequency) and of an access contention resolution diversity CRD.

These protocols are all random protocols in which each user terminal accesses the transmission resources independently with respect to the other users. For each packet transmitted, the user expects an acknowledgement from the recipient. If he or she does not receive it, he or she retransmits the same data with a random delay and this mechanism is iterated until an acknowledgment is received or until a maximum number of attempts has been made.

It is known practice to couple the use of a random access via a random access channel RACH and the use of a demand assigned multiple access in DAMA mode via an assigned multiple access channel according to this mode to send, for example, from a user terminal, a traffic surplus if the capacity of the demand assigned multiple access in DAMA mode is not sufficient.

A first document, an article by Dennis Connors et al., entitled “A Quality of Service based Medium Access Control Protocol for Real-Time Sources”, Mobile Networks and Applications 1999, describes such a coupling of use of a random access RA and a demand assigned multiple access DAMA. The switchover between the use of the RA mode and the use of the DAMA mode is based on the level of filling of the RA and DAMA queues of the user terminal to select the channel to be used from the RA channel and the channel allocated in DAMA mode.

A second document, the patent application EP 1 686 746 A1, also describes a coupling of use of a random access RA and of a demand assigned multiple access DAMA. This second document describes how, at a given instant, the queue of a terminal contains Q packets and a capacity reservation for K packets has been made. The first K packets of the queue will be transmitted by a DA method, by using the capacity which has already been reserved; the terminal must choose between two possibilities: either to transmit the Q-K remaining packets by a CRDSA method, or to make another capacity reservation request to transmit them by a DA method. According to a preferred embodiment of the second document, at any instant, the terminal is either in RA mode, in which case it makes capacity requests to transmit according to a method of assignment according to demand. The content in bits of the queue on execution of the packets for which a capacity reservation has already been made, indicated (Q-K)bits, is compared to two threshold values, a first threshold value and a second threshold value strictly lower than the first value. If the terminal is in RA mode and (Q-K)bits goes above the first threshold, it switches over to DA mode. Conversely, if (Q-K)bits drops below the second threshold when the terminal is in DA mode, the latter switches to RA mode (but the K packets for which a capacity reservation has been made will nevertheless be transmitted by the DA method). Thus, in this second document, the switchover between the use of the RA mode and the use of the DAMA mode is based also on the level of filling of the RA and DAMA queues of the user terminal to select the channel to be used from the RA channel and the channel allocated in DAMA mode.

Despite the solutions proposed in the two documents and described above, the random access channel RACH is little used to transfer useful data and remains primarily used for standard access and signalling phases (called access-request, logon for example), on the one hand because of the low efficiency inherent to this type of channel (typically approximately 25% for a stable access on an RACH channel of slotted Aloha or SA type), and on the other hand because of the risks of terminal entry delays in the system.

Furthermore, none of the current solutions, notably those described in the first and second documents, makes it possible to effectively transfer small, sporadic and unpredictable volumes of data.

The technical problem is to improve the capacity and the transfer efficiency of a method for transmitting data packets or packet fragments, switched between a random access channel RACH and a demand assigned multiple access DAMA channel, when the input traffic is traffic of small, sporadic and unpredictable volumes of data.

### SUMMARY OF THE INVENTION

To this end, the subject of the invention is a method for transmission over an uplink of data packets and of packet fragments from a terminal TE out of a plurality of terminals to a gateway GW, the data packets or packet fragments being switched between a first random access mode using a random access channel RACH and a second demand assigned multiple access DAMA mode using a demand assigned multiple access DAMA channel, and the random access channel RACH being shared by the plurality of terminals; the transmission method being characterized in that it comprises the following step in which:
in a first step, the terminal concerned TE receives, almost in real time from the gateway via a downlink, one or more information items representative of the current transmission resources allocated to the random access channel RACH and to the demand assigned multiple access DAMA mode;
in a second step, the terminal TE routes the data packets or packet fragments over the random access channel RACH via a random access or a demand assigned multiple access channel via a demand assigned multiple access DAMA according to the size of the packets and their class of service, and information items representative of the current transmission resources allocated to the random access channel RACH and to the demand assigned multiple access DAMA mode, the information items representative of the current transmission resources allocated being supplied and transmitted to the terminals of the plurality over a return link.

According to particular embodiments, the transmission method comprises one or more of the following features:
the second step comprises a third step of implementation of a classification and of a first routing of the packets during which the terminal classifies the packets according to their size and their class of service in terms of quality of service (QoS) and routes the packets according to this classification either to a uniform first set of queues connected exclusively to the demand assigned multiple access, or to a mixed second set of queues that can be connected separately and selectively in time to one of the two accesses taken from the random access RA and the demand assigned multiple access DAMA;
the terminal prioritizes the routing of the short data packets of low data volume corresponding to sporadic traffic over the random access channel RACH;
the second step comprises a fourth step consecutive to the third step during which the packets, delivered at the output of the queues of the mixed second set, are fragmented into one or more packet fragments according to the size of the packets, then the packets or the packet fragments are scheduled according to respective priorities associated with the packets and determined by the quality of service classes of said packets, then the packets or the packet fragments are pre-assigned, through an access mode pre-assignment information item, to an access mode, taken from the RA access mode and the DAMA access mode, according to information items representative of the current transmission resources allocated and a predetermined convergence type, taken from a partial convergence and a total convergence, then the packets or the packet fragments are encapsulated according to an encapsulation protocol which depends on the convergence type, then the packets or the packets fragments are routed to one of the two accesses taken from the random access RA and the demand assigned multiple access DAMA according to the pre-assigned access mode;
when the convergence type is a partial convergence, the encapsulation protocol used is a conventional protocol which does not unambiguously identify the fragments of the packets, and which is transparent to the gateway acting as receiver, and when the random access RA mode has resources available, the packets or the packet fragments deriving from the mixed second set after fragmentation use the random access RA as a priority; and when the random access RA mode has no more resources available, the packets or the packet fragments deriving from the mixed second set after fragmentation are redirected to the demand assigned multiple access DAMA mode; and when a switchover from the RA access mode to the DAMA access mode takes place, the packet or the packet fragments currently being sent to the RA access mode before the switchover are all retransmitted to the demand assigned multiple access DAMA;
when the convergence type is a partial convergence, a mechanism of ARQ (Automatic Repeat reQuest) type is implemented in the convergence layer implemented in the fourth step;
when the convergence type is a total convergence, the encapsulation protocol used is an encapsulation protocol configured to unambiguously identify the content of each fragment of a packet deriving from the mixed second set through an information item identifying the content of each fragment of a packet; and the access mode of each packet fragment is selected according to the next opportunity for transmission to one of the two accesses, the next opportunity for transmission being the instant closest to the current instant out of the instant of the next transmission over the RACH channel, and the instant resource(s) possibly already assigned to the DAMA access become(s) available;
when the convergence type is a total convergence, the encapsulation protocol used is: either a conventional encapsulation protocol modified in terms of the use of a reserve of signalling bits, existing in a field of the frame of the protocol not conventionally used, or an augmented conventional encapsulation protocol in which a bit field has been added to the field of existing bits of the protocol, or a new protocol;
the information items representative of the current transmission resources allocated to the random access channel RACH are obtained from a first estimated probability of reception of an empty expected burst Pₑ, or from a pair of estimated probabilities formed by the measured first probability Pe and a second probability of reception of an empty burst Pₛ, or from a third estimated probability of a burst having undergone a collision P_{c}; the probabilities Pe alone, or Pe and Ps, or Pc alone being estimated continuously by the gateway GW, over an observation window of predefined width and from measurements in reception in said observation window of the expected bursts; and the third step forming part of the transmission method and being executed before the first step;
the information items representative of the current transmission resources allocated to the random access channel RACH are contained in the set formed by the current composition of the random access channel and/or the current list of the classes of terminals authorized to transmit and of the classes of terminals not authorized to transmit; and the estimated probabilities Pe alone, or Pe and Ps, or Pc alone; and the external input load of the RACH channel estimated from the estimated probability Pe;
the transmission method further comprises a method for dynamically adapting the capacity of the random access channel, the method for dynamically adapting the capacity being characterized in that it comprises the following steps:
   in a first step, setting the value of a desired external load as nominal operating point of the channel, the real external load of the channel being equal to the current rate of new terminals coming online transmitting a respective burst of data over the channel;
   in a second step, continuously estimating, over an observation window of predefined width and from measurements in reception in said observation window of the expected bursts, a first measured probability of reception of an empty expected burst Pe, or a pair of measured probabilities formed by the first measured probability Pe and a second measured probability of successful reception of a burst Ps, or a third measured probability of a burst having undergone a collision Pc;
   in a third step, determining, using a mathematical model or a simulation, a high first threshold S_{H} and a low second threshold S_{L} of a quantity Gr monotonically sensitive to the external load of the random access channel, the high and low external loads of the random access channel corresponding respectively to the high first threshold or low second threshold, the sensitive quantity Gr depending on the first probability Pe or on the third probability Pc or on the pair of probabilities (Pe, Ps) and on the type and on parameters defining the random access protocol;
   in a fourth step, determining the current sensitive quantity as a function of one or both of the measured probabilities;
   in a decision-making fifth step, when a crossing of the high first threshold by the current sensitive quantity occurs one or more times consecutively moving away from the value of the quantity corresponding to the nominal external load, increasing the current capacity of the transmission channel by releasing additional communication resources in terms of additional frequencies and by informing the terminals by a return link of the new composition of the transmission channel with increased capacity; and/or when a crossing of the low second threshold occurs by the current sensitive quantity one or more times consecutively moving away from the value of the quantity corresponding to the nominal external load, reducing the current capacity of the transmission channel by withdrawing communication resources in terms of frequencies from the transmission resources currently made available and by informing the terminals by the return link of the new composition of the transmission channel with reduced capacity;
the transmission method further comprises a flow control method, coupled to said capacity adaptation method and which comprises the following steps in which:
   the gateway GW supplies a current list of classes of terminals distinguishing the classes of the terminals authorized to transmit and the classes of the terminals from which transmission is prohibited, and
   when the crossing of the high first threshold S_{H} induces a decision to increase the capacity of the channel and a predetermined maximum size of the channel is reached, the gateway triggers an increase in the flow control level by prohibiting a class of terminals authorized to transmit in the current list from transmitting, chosen randomly from the current list, by updating the list of the classes authorized to transmit and by notifying the terminals by the return link of the updated list of the classes authorized to transmit; and
   when the crossing of the low second threshold S_{L} induces a decision to reduce the capacity of the channel, the gateway triggers a lowering of the flow control level by authorizing a class of terminals prohibited from transmitting in the continuation current list to transmit, chosen randomly from the current list, by updating the list of the classes authorized to transmit and by notifying the terminals by the return link of the updated list of the classes authorized to transmit.

Also a subject of the invention is a system for transmitting data or packet fragments, comprising a plurality of user terminals and a connection gateway GW to a second network, each terminal being configured to transmit to the gateway GW over an uplink data packets or packet fragments, switched between a first random access mode using a slotted random access channel RACH shared by the plurality of terminals and a second demand assigned multiple access DAMA mode using a demand assigned multiple access DAMA channel; the transmission system being characterized in that each terminal is configured to receive, almost in real time from the gateway via a return link, one or more information items representative of the current transmission resources allocated to the random access channel RACH and to the demand assigned multiple access DAMA mode; and each terminal is configured to route the data packets or the packet fragments over the random access channel RACH via a random access or a demand assigned multiple access channel via a demand assigned multiple access DAMA according to the size of the packets and their class of service, and information items representative of the current transmission resources allocated to the random access channel RACH and to the demand assigned multiple access DAMA mode, the information items representative of the current transmission resources allocated being supplied and transmitted to the terminals of the plurality over a return link.

According to particular embodiments, the transmission system comprises one or more of the following features:
the connection gateway GW is configured to implement the steps consisting in continuously estimating, over an observation window of predefined width and from measurements in reception in said observation window of the expected bursts, a first measured probability of reception of an empty expected burst Pe, or a pair of measured probabilities formed by the first measured probability Pe and a second measured probability of successful reception of a burst Ps, or a third measured probability of a burst having undergone a collision Pc; determining a current quantity Gr monotonically sensitive to the external load of the random access channel RACH from the first estimated probability Pe or from the third probability Pc or from the pair of probabilities (Pe, Ps) and from the parameters defining the random access protocol; then when a crossing of a high first threshold S_{H} by the current quantity occurs one or more times consecutively moving away from the value of the quantity corresponding to the nominal external load, increasing the current capacity of the transmission channel by releasing additional communication resources in terms of additional frequencies and by informing the terminals by a return link of the new composition of the transmission channel with increased capacity; and/or when a crossing of the low second threshold S_{L} occurs by the current sensitive quantity one or more times consecutively moving away from the value of the quantity corresponding to the nominal external load, reducing the current capacity of the transmission channel by withdrawing communication resources in terms of frequencies from the transmission resources currently made available and by informing the terminals by the return link of the new composition of the transmission channel with reduced capacity;
the connection gateway GW and the terminals TE are configured to implement a flow control mechanism and a congestion control mechanism through the regular and frequent supply by the connection gateway of a current list of classes of terminals authorized to transmit and of classes of terminals not authorized to transmit.

Also a subject of the invention is a terminal for transmitting, over an uplink, data packets or packet fragments of data packets or packet fragments, switched between a first random access mode using a random access channel RACH and a second demand assigned multiple access DAMA mode using a demand assigned multiple access DAMA channel, the terminal being characterized in that it comprises:
a first random access RA and a second demand assigned multiple access DAMA respectively comprising a first RA queue connected to a first RA access output terminal and a second DAMA queue connected to a second DAMA output terminal (236); and
a uniform first set of queues connected exclusively to the second demand assigned multiple access; and
a mixed second set of queues that can be connected separately and selectively in time to one of the two accesses taken from the first random access RA and the second demand assigned multiple access DAMA; and
a unit for classification and first routing of the packets, configured to classify the packets according to their size and their class of service in terms of quality of service (QoS), and route the packets according to this classification either to the uniform first set of queues, or to the mixed second set of queues.

According to particular embodiments, the transmission terminal comprises one or more of the following features:
the terminal further comprises a processing and convergence unit connected upstream to a packet input terminal to the first and second sets of queues and upstream to the first and second accesses, and an RA and DAMA access resource management agent connected between a return link port for receiving signalling signals and the processing and convergence unit;
the access resource management agent being configured to:
   monitor the information items representative of the current transmission resources available on the random access channel RACH and on the demand assigned multiple access DAMA mode, and
   initiate resource requests according to the filling of the queues of the first and second sets;
the processing and convergence module being configured to:
   fragment the packets, delivered at the output of the queues of the mixed second set, into one or more packet fragments according to the size of the packets, then
   schedule the packets or the packet fragments according to respective priorities, associated with the packets and determined by the quality of service classes of said packets, then
   pre-assign the packets or the packet fragments through an access mode pre-assignment information item, to an access mode, taken from the first RA access and the second DAMA access, according to information items representative of the current transmission resources allocated to the RA and DAMA accesses and according to a predetermined convergence type, taken from a partial convergence and a total convergence, then
   encapsulate the packets or the packet fragments according to an encapsulation protocol which depends on the convergence type, then
   route the packets or the packet fragments to one of the two accesses taken from the random access RA and the demand assigned multiple access DAMA according to the pre-assigned access mode.

Also a subject of the invention is a computer program comprising instructions for the implementation of the transmission method as defined above, when the program is executed by one or more processors of a transmission system as defined above.

### BRIEF DESCRIPTION OF THE DRAWINGS

The invention will be better understood on reading the following description of a number of embodiments, given purely by way of example and with reference to the drawings in which:

FIG. 1 is a schematic view of a transmission system according to the invention, configured to implement a method for transmitting data packets or packet fragments switched between a random access channel RACH and a demand assigned multiple access DAMA mode channel;

FIG. 2 is a flow diagram of a method according to the invention for transmitting data packets or packet fragments switched between a random access channel RACH and a demand assigned multiple access DAMA mode channel implemented by the transmission system of FIG. 1;

FIG. 3 is a view of the architecture of a terminal TE, incorporated in the system of FIG. 1 and configured to implement the transmission method according to the invention of FIG. 2;

FIG. 4 is a comparative view of the signalling interchanges required for a transfer of a small volume of user data from a terminal to the gateway between a first conventional transmission configuration in which the random access channel RACH is used only in the network access phase and other channels of a DAMA mode are used for the actual transfer of the user data, and a second configuration using the invention in which the RACH channel effectively transfers the user data;

FIG. 5 is a comparative view of the performance levels in terms of delay between a first system using only a random access channel RACH of CRDSA type for the transmission of sporadic and unpredictable traffic and a second DVB-RCS2 system using demand assigned DA channels;

FIG. 6 is a flow diagram of a particular embodiment of the transmission method of FIG. 2.

### DETAILED DESCRIPTION

The invention is described below with reference to a satellite communication system in which a plurality of users, each having a specific user terminal TE (terminal equipment) are linked via a bent pipe satellite with multiple beams to gateways G allowing access to a terrestrial network. This does not limit the scope of the invention which can be applied to different communication systems using, for example, regenerative satellites and/or terrestrial wireless connections, even cable connections.

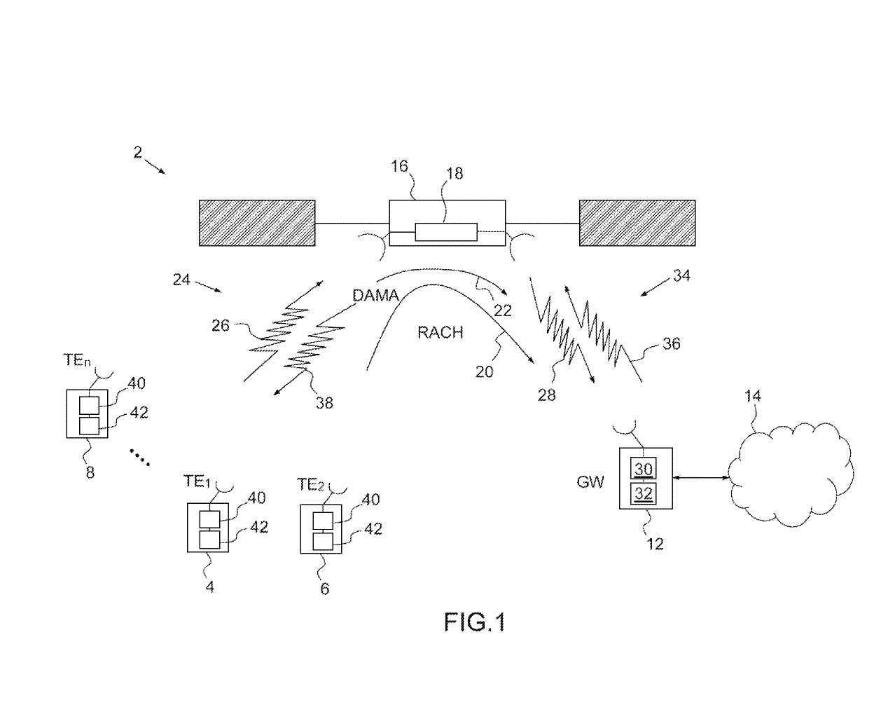

According to FIG. 1, a satellite communication system 2, configured to implement the invention, comprises a number n of terrestrial user terminals TE₁, TE₂, . . . TEₙ, only three terminals 4, 6, 8 corresponding to the respective designations TE₁, TE₂, TEₙ being represented in FIG. 1 in the interests of simplicity, a connection gateway 12 to a second network 14 such as, for example, the internet network, and a satellite 16 SAT.

The satellite 16 comprises a bent pipe payload 18 or a regenerative payload with onboard processing which serves as a relay between the terminals 2, 4, 6 and the connection gateway 12. The terminals 4, 6, 8 are each configured to transmit, in burst form, data packets or packet fragments to the connection gateway 12 by selectively switching the bursts between a first access mode using a random access channel 20, designated RACH, and a second demand assigned multiple access DAMA mode using a demand assigned multiple access channel 22. The random access channel RACH 20 and the demand assigned multiple access channels 22 form an uplink 24, subdivided into a first upstream connection 26 from the terminals 4, 6, 8 to the satellite 16 and a second upstream connection 28 from the satellite 16 to the connection gateway 12.

A signalling return downlink 34 is used to send from the connection station 12 to the terminals 4, 6, 8 one or more information items representative of the current transmission resources allocated to the random access channel RACH and to the demand assigned multiple access DAMA mode.

The downlink 34 is subdivided into a first downstream connection 36 from the connection station 12 to the satellite 16 and a second downstream connection 38 from the satellite 16 to the terminals 4, 6 and 8.

Preferably, when the traffic distribution strategy aims to minimize the number of resources allocated overall to the random access channel 20 and to the demand assigned multiple access channels 22, and therefore to maximize the use of the random access channel 20 for the packets, the method as described in the patent application entitled “Method for Dynamically Adapting the Capacity of a Random Access Transmission Channel” and filed jointly with the present application, is used.

In this case, the connection gateway 12 is configured to receive and demodulate, using a gateway receiver 30, the bursts of the data packets or of the packet fragments transmitted by the terminals 4, 6, 8 over the uplink random access transmission channel RACH 20 or over the demand assigned multiple access channels 22 in DAMA mode.

The connection gateway 12 is configured also to dynamically adapt the capacity of the random access channel 20 RACH and the total capacity of the demand assigned multiple access channels 22 in DAMA mode according to unpredictable traffic from terminals coming online and a traffic distribution strategy between the first RA mode and the second DAMA mode.

The dynamic adaptation is implemented through processing steps, executed by a gateway processing unit 32, and a step of regular and continuous notification to all the terminals 4, 6, 8 of the composition of the resources of the first RA mode allocated to the random access channel 20 and of the resources of the second DAMA mode allocated to the demand assigned multiple access channels 22, the notification being made through a return link 34 requiring a low capacity. When the classes of terminals are defined, a flow control mechanism can be implemented by the regular and continuous notification to all the terminals 4, 6, 8 and in addition to an updated list of the classes of terminals authorized to transmit by the gateway.

Generally, each terminal 4, 6 and 8 comprises a transceiver 40 and a terminal processing unit 42, configured to receive the management information items for the random access channel 20 RACH and for the demand assigned multiple access channels 22 in DAMA mode, sent by the connection station 12 over the downlink 34, and to use these information items.

As a variant and in addition to the implementation of an optional flow control mechanism, coupled to the method for dynamically adapting the capacity of the RACH transmission channel 20, the terminals 4, 6, 8 are configured to implement a channel congestion control mechanism in which the spread of the retransmission delays from the terminals authorized to transmit is an ascending function of a flow control level representative of the degree of congestion of the channel.

The random access channel RACH uses a slotted or asynchronous random access protocol.

The slotted random access protocol is included for example in the set formed by the ALOHA protocol with time or slotted segmentation (slotted ALOHA) and its derivatives combining the capture effect CE and/or the effect of use of a diversity (time or frequency) and of an access contention resolution diversity CRD.

An asynchronous random access protocol is, for example, an ESSA (Enhanced Spread Spectrum ALOHA) protocol or an SMIM (S-band Mobile Interactive MultiMedia) protocol.

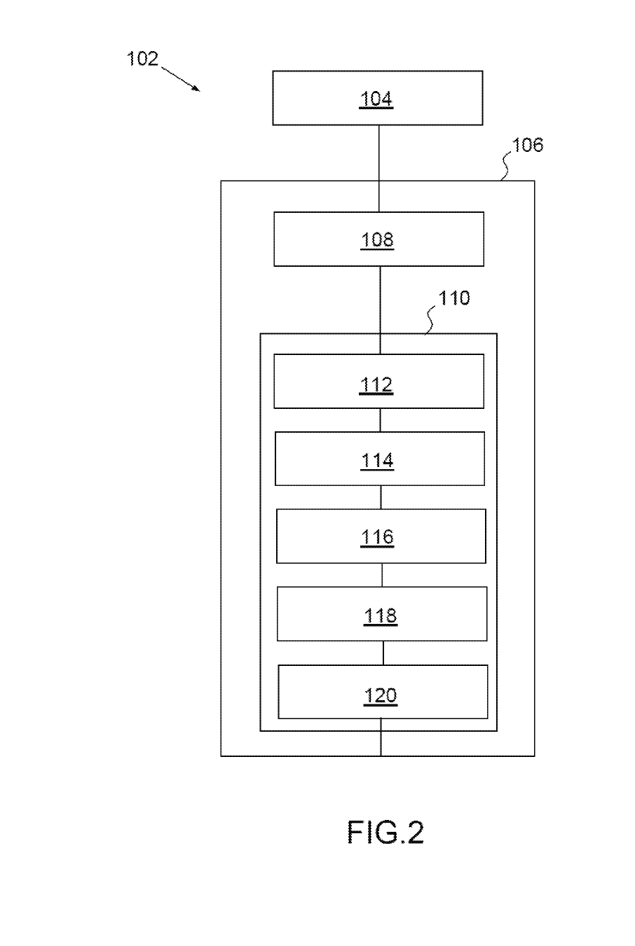

According to FIG. 2, and generally, a method for transmission 102 over a forward link of data packets or packet fragments from a terminal TE taken from a plurality of terminals to a gateway GW is implemented, for example, by the transmission system described in FIG. 2.

The data packets or packet fragments are switched between the first random access mode using the slotted random access channel 20 RACH and the second demand assigned multiple access DAMA mode using a demand assigned multiple access channel 22.

The random access channel RACH 20 is shared by the plurality of terminals 4, 6, 8.

The transmission method 102 comprises a first step 104 followed by a second step 106.

In the first step 104, the terminal concerned TE receives, almost in real time from the connection gateway 12 via the return link 34, one or more information items representative of the current transmission resources allocated to the random access channel RACH and to the demand assigned multiple access DAMA mode.

Then, in the second step 106, the terminal concerned TE routes the data packets or the packet fragments to the random access channel 20 RACH via a random access of the terminal or to a demand assigned multiple access channel 22 via a demand assigned multiple access DAMA of the terminal according to the size of the packets and their class of service, and information items representative of the current transmission resources allocated to the random access channel 20 RACH and to the demand assigned multiple access DAMA mode. The information items representative of the current transmission resources allocated are supplied and transmitted to the terminals 4, 6, 8 of the plurality over the return link 34.

According to the approach of the invention, and contrary to what is conventionally proposed, the explicit or implicit state of the random access channel 20 in terms of a quantity representative of the external load of the RACH channel 20 is taken into account to transmit useful traffic (different from the transmission-specific signalling) as a priority over this channel 20 and more effectively in terms of use of the resource than over the demand assigned multiple access channel 22 in the second DAMA mode.

Here, and contrary to what is conventionally proposed, the level of filling of the queues of the terminal is not used. Here, the load and/or congestion level of the random access channel 20, transmitted implicitly or explicitly by the connection gateway 12 and received by the terminals, is used as a priority and predominantly.

This novel approach is suited in particular to the transmission of some or all of sporadic and unpredictable traffic which is generally and conventionally sent in DAMA mode or in “circuit” mode.

This novel approach makes it possible to avoid, in circuit mode, the reservation and the immobilization of resources for a long period, to avoid, in DAMA mode, a volume of signalling and a significant associated delay as well as a sub-optimal use of the potential resources, while the aim is to transmit one or more useful data messages, often a single message.

The second step 106 comprises a third step 108 followed by a fourth step 110.

The third step 108 is a step of classification and of a first routing of the packets during which the terminal TE classifies the packets according to their size and their class of service in terms of quality of service (QoS). The terminal TE then routes the packets according to this classification, either to a uniform first set of queues connected exclusively to the demand assigned multiple access, or to a mixed second set of queues that can be connected separately and selectively in time to one of the two accesses taken from the random access RA and the demand assigned multiple access DAMA.

The fourth step 110, following the third step 108, is a step during which the packets, delivered at the output of the queues of the mixed second set, are fragmented 112 into one or more packet fragments according to the size of the packets. Then, in the same step 110, the packets or the packet fragments are scheduled 114 according to respective priorities, associated with the packets and determined by the quality of service classes of said packets. Then, the packets or the packet fragments are pre-assigned 116, through an access mode pre-assignment information item, to an access mode, taken from the RA access mode and the DAMA access mode, according to the information items representative of the current transmission resources allocated and a predetermined convergence type, taken from a partial convergence and a total convergence. Then, the packets or the packet fragments are encapsulated 118 according to an encapsulation protocol which depends on the convergence type. Then, the packets or the packet fragments are routed 120 to one of the two accesses taken from the random access RA and the demand assigned multiple access DAMA according to the pre-assigned access mode.

Two convergence types, a partial convergence and a total convergence, can be implemented. The choice of the convergence type depends on the communication system concerned and on the strategy envisaged regarding the complexity and the efficiency of use of the transmission resources.

In both cases, a terminal-side information item representative of the load and/or congestion level of the random access is used so as not to congest the TACH channel which remains reserved as a priority for signalling, generally the “logon”.

In the first case of a partial convergence, a limited modification of the access is necessary and a transparency for the protocol stacks is observed. The partial convergence layer is defined so as to allow the selection and the priority transmission over the random access channel RACH of appropriate messages such as messages of a sporadic service, short messages or messages with certain traffic requirements. If the transmission over the random access channel fails or if the congestion level of the RACH channel is too high, the messages are then transmitted over a demand assigned multiple access channel in DAMA access mode. This partial convergence layer is positioned upstream of the two types of access (RA and DAMA) and below the network layer, but remains relatively transparent for the data link level (encapsulation, fragmentation/reassembly).

The transmission efficiency conferred by this convergence type is not maximal for this convergence type. However, this partial convergence can already significantly improve the use of the resources of the current communication systems and does not require any modification of the existing protocol stacks, only the addition of the convergence layer on the terminal side.

In the second case of a total convergence, a common management of both the RA and DAMA accesses is performed. This approach thus allows for a great flexibility of use of both the RA and DAMA accesses and an optimal use of the transmission resources according to the availability thereof and the quality of service (QoS) requirements of the communications. For that, the preferred messages to be transmitted in RA mode are selected based on the characteristics of the traffic and its quality of service (QoS) requirements. If such messages exist, a part of this traffic will be able to be transmitted in the first RA access mode and another part of the traffic in the second DAMA access mode according to the availability of the transmission resources in each access and the priority of the traffic.

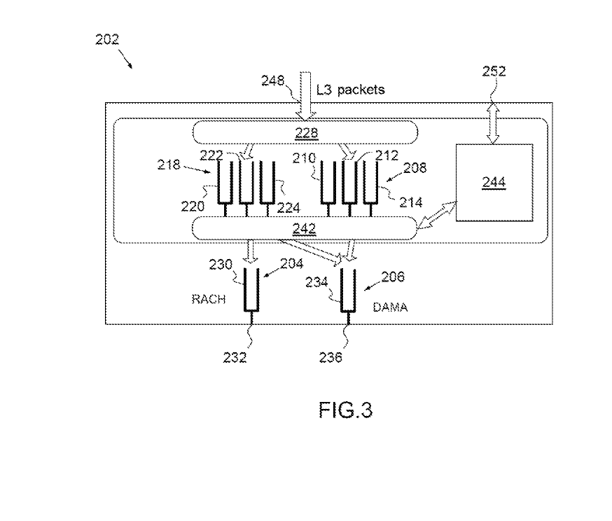

Both types of convergence use an identical terminal architecture described in FIG. 3.

According to this architecture, each terminal TE, 4, 6, 8, here a generic terminal 202 being represented, comprises a first random access 204 RA and a second demand assigned multiple access 206 DAMA, a uniform first set 208 of queues 210, 212, 214, a mixed second set 218 of queues 220, 222, 224, a unit 228 for classification and first routing of the packets.

The first access 204 and the second access 206 respectively comprise a first RA queue 230, connected to a first RA access output terminal 232, and a second DAMA queue 234, connected to a second DAMA output terminal 236.

The queues 210, 212, 214 of the uniform first set 208 are connected exclusively to the second demand assigned multiple access 206.

The queues 220, 222, 224 of the mixed second set 218 can be connected separately and selectively in time to one of the two accesses 204, 206 taken from the first random access 204 RA and the second demand assigned multiple access 206 DAMA.

The unit 228 for classification and first routing of the packets of level 3 according to the OSI layered model, or L3 packets, is configured to classify the L3 packets according to their size and their class of service in terms of quality of service (QoS), and route the packets according to this classification either to the uniform first set 208 of queues 210, 212, 214, or to the mixed second set 218 of queues 220, 222, 224.

Independently of the convergence type used, the classification of the traffic is performed according to the characteristics of the traffic (sporadic nature, sizes of the packets) and its requirements in terms of quality of service. Thus, the level 3 packets are routed either to the queues 210, 212, 214 of the first set 208 associated with the demand assigned multiple access channel only of the second access 206, or to the queues 220, 222, 224 of the second set allowing access to both the demand assigned multiple access and the random access. Within the mixed second set 218 of queues, a classification of the L3 packets can be performed to redirect these packets to a queue associated with a specific class of service.

A distinct classification can be implemented in the case of a partial convergence or of a total convergence. In effect, given the greater flexibility of access in the case of the total convergence, a greater portion of the traffic can be routed to the mixed part (random access and demand assigned multiple access queues) if relevant in terms of resources allocated to the random access channel.

The terminal 202 also comprises a processing and convergence unit 242 and an RA and DAMA access resource management agent 244.

The processing and convergence unit 242 is connected upstream to an input terminal 248 for inputting the L3 packets to the first and second sets 208, 218 of queues and downstream to the first and second accesses 204, 206.

The RA and DAMA access resource management agent 244 is connected between a return link port 252 for the reception of signalling signals and the processing and convergence unit 242.

The access resource management agent 244 is configured to:
monitor the information items representative of the current transmission resources available on the random access channel RACH and on the demand assigned multiple access DAMA mode, and
initiate resource requests according to the filling of the queues of the first and second sets 218 and 208.

The processing and convergence module 242 is configured to:
fragment the packets L3, delivered at the output of the queues of the mixed second set, into one or more packet fragments according to the size of the packets L3, then
schedule the packets or the packet fragments according to respective priorities, associated with the packets and determined by the quality of service classes of said packets, then
pre-assign the packets or the packet fragments, through an access mode pre-assignment information item, to an access mode, taken from the first RA access and the second DAMA access, according to information items representative of the current transmission resources allocated to the RA and DAMA accesses and a predetermined convergence type, taken from a partial convergence and a total convergence, then
encapsulate the packets or the packet fragments according to an encapsulation protocol which depends on the convergence type, then
route the packets or the packet fragments to one of the two accesses taken from the random access RA and the demand assigned multiple access DAMA according to the pre-assigned access mode.

The RA and demand assigned multiple access resource management agent 244 which makes it possible to monitor the transmission resources and initiate the resource requests when necessary has a substantially identical functional and physical architecture for both convergence types. It centralizes all the information items linked to the availability of the resources on the two accesses 204 and 206 such as the flow control and congestion level on the random access channel RACH and the allocations of resources to the second DAMA access mode. It makes the resource requests according to the filling of the queues of the convergence layer and a predetermined resource allocation or reservation cycle.

The ways that the processing and convergence unit 242 and the resource management agent 244 operate differ according to the convergence type used.

When the convergence type is a partial convergence, the encapsulation protocol used is a conventional protocol which does not unambiguously identify the fragments of the packets, and which is transparent to the gateway acting as receiver.

In this case, when the random access RA mode has resources available, the packets or the packet fragments deriving from the mixed second set after fragmentation use the random access RA as a priority.

When the random access RA mode no longer has resources available, the packets or the packet fragments deriving from the mixed second set after fragmentation are redirected to the demand assigned multiple access DAMA mode.

Furthermore, when a switchover from the RA access mode to the DAMA access mode occurs, the packet or the packet fragments currently being sent on the RA access mode before the switchover are all retransmitted to the demand assigned multiple access DAMA.

In this case, the encapsulation part is identical to the so-called “legacy” existing conventional encapsulations, which makes it possible for the partial convergence to be totally transparent to the connection station GW, considered as the receiver of the forward connection.

The selection of the access for the traffic coming from the mixed queues of the mixed second set 218, that is to say the traffic that can use a demand assigned multiple access or a random access without preference, takes into account the availability of the resource for the two accesses that it obtains from the resource management agent. This traffic is directed and sent on the random access channel RACH if transmission resource is available on this channel. If resource on the random access channel is not or is no longer available, because of a notification received by the terminal TE that the flow control and/or the congestion control are activated for example, the traffic is redirected to the second demand assigned multiple access mode channel. The packet which could not then all be transmitted over the RACH channel, that is to say all the fragments of this packet, must be completely retransmitted over the demand assigned multiple access channel.

Optionally, if an ARQ mechanism is not implemented at the application layer or at level 2 and depending on the required transmission quality and the level of modification tolerated in the receiver, a mechanism of ARQ (Automatic Repeat reQuest) type is added and implemented at the level of the convergence layer implemented in the fourth step.

The addition of a simple segmentation and reassembly protocol in RA mode makes it possible to ensure the transporting of the data from a user in “unconnected” mode by implementing, for example, a mechanism of the “send and await acknowledgement” type with a unitary window corresponding to the transmission of a message by message, and by supplying at least over the uplink a unique identifier of the transmitter, the message number, the numbers of the segments of the data to be transmitted. On correct reception, the receiver, that is to say the gateway GW, responds to the transmitter, that is to say the terminal TE, via a common channel of broadcast type by sending as information items: the identifier of the transmitter, the message number and the list of the segments of a message received and not received. A segment can be retransmitted if it has not been correctly received by the receiver GW.

The protocol described above also allows for the transporting of access control messages, for example resource request and maintenance messages of the RACH channel.

When the convergence type is a total convergence, the encapsulation protocol used is an encapsulation protocol configured to unambiguously identify the content of each fragment of a packet deriving from the mixed second set 218 through an information item identifying the content of each fragment of a packet. The access mode of each packet fragment is selected according to the next opportunity for transmission on one of the two RA and DAMA accesses. The next opportunity for transmission is the instant closest to the current instant out of the instant of the next transmission on the RACH channel, and the instant when resource(s) possibly already assigned to the DAMA access is/are made available.

The instant of the next transmission over the RACH channel is defined on the basis of one or more timers T1, T2, one of them being randomly drawn according to a predetermined draw law, and the parameterizing of this law being able to depend on the state of the classes of the terminals authorized to transmit. A procedure for defining instants of transmission by a terminal over the RACH channel is described for example in the patent application EP 2787702 A1 or in the patent application entitled “Method for Dynamically Adapting the Capacity of a Random Access Transmission Channel” and filed jointly with the present application.

An additional encapsulation is required to take account of the concurrent transmission over both the first RA mode and second DAMA mode accesses, which means implementing an equivalent encapsulation layer on the receiver, that is to say at the gateway GW.

The selection of the access coming from the mixed queues of the second set is performed in this case only according to the next opportunity for transmission over one of the two accesses, which can be alternately over one or other of the channels with different access modes. Unlike the partial convergence, a packet can be transmitted partly over the random access and partly over the demand assigned multiple access. The segmentation and reassembly layer takes account of the two different access modes in order to unambiguously identify the content of a packet fragment to be transmitted by the transmitter of the terminal TE and to correctly reassemble the data by the connection station GW. Thus, one or more fragments of a packet can use the RA channel while the remaining fragments of the same packet can use the DAMA channel with burst sizes that can be different to those of the RACH channel.

When the convergence type is a total convergence, the encapsulation protocol used can be:
either a conventional encapsulation protocol modified in terms of the use of a reserve of signalling bits, existing in a field of the frame of the protocol not conventionally used,
or an augmented conventional encapsulation protocol in which a bit field has been added to the field of existing bits of the protocol,
or a new protocol.

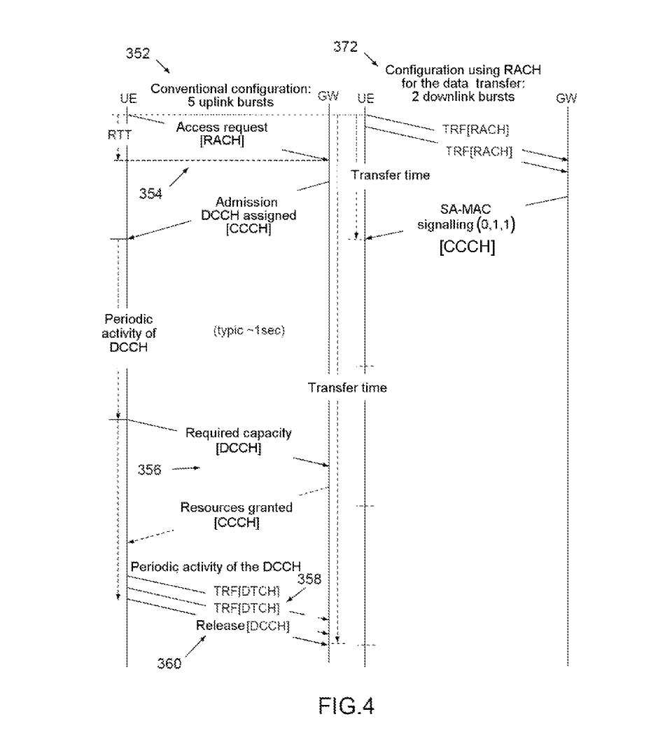

According to FIG. 4, a first conventional configuration 352 for the transmission or transfer of data between a terminal TE and a gateway GW uses a first random access channel RACH and a second DAMA mode channel, coupled to the first RACH channel and generally comprises four steps or phases.

In a first phase 354, the terminal TE accesses the network via the random access channel RACH, defined by a logical time segmentation frame and shared between users, and awaits, as response from a CCCH (Common Control Channel) notification channel, at least a minimum control resource allocation.

Then, in a second phase 356, the terminal TE requests dedicated resources (DAMA mode) via the dedicated control channel DCCH which was allocated to it in the first phase 354 to handle the data which may be useful data of a user service but also signalling and/or control data for the transmission system such as, for example, synchronization, power control, and other such data.

Next, in a third phase 358, the terminal TE transfers the useful volume of data to the gateway GW over the allocated resources, in this case a dedicated traffic channel DTCH, allocated in the second phase 356 to the notification channel CCCH.

Then, in a fourth phase 360, the DCCH and DTCH resources allocated in the first and second phases 354, 356 are released at the end of the transfer.

The control channel DCCH is generally dedicated to a multiplexed circuit between the terminals TE.

The resources allocated are: either in DAMA mode (mostly the case), or in PAMA or “circuit” mode, possibly multiplexed.

This first data transfer configuration 352 can be used and is used to transfer low volumes of data.

The typical applications which require a low volume of data are, for example, of gathering type, remote measurements/sensors, alarms, SMS equivalents. Another application can also be the MAC/DAMA layer signalling (capacity request, maintenance-synchronization, etc.).

This first data transfer configuration 352 is inefficient for transferring sporadic low volumes of data. In effect, the ratios of the volume of the useful data to the total volume of the resources allocated and the useful transfer time to the total session time are low for this configuration.

A second configuration 372, described in FIG. 4, is proposed to mitigate this inefficiency. The second data transfer configuration 372 advantageously exploits the flexibility of the updating of the capacity of the RACH channel provided by the method for adapting the capacity of the RACH channel in order to directly transfer the data over this RACH channel, thus maximizing the instantaneous capacity required without a collapse of the channel, and minimizing the useful resources and the transfer session times.

The user data is then segmented over a few uplink bursts by the terminal TE then reassembled by the gateway GW. A light protocol in connectionless mode between the terminal TE and the gateway GW is implemented in order to be able to retransmit any data segments (“segments received/not received list” type, for example) when a burst collision occurs. The number of uplink bursts required depends directly on the size of the payload of one according to the performance levels of the waveform used in terms, for example, of guard time, of modulation/coding.

By considering, for example, two useful uplink bursts to convey the data of a user TE, the diagrams of the interchanges dimensioned for the transfer of these two useful bursts make it possible to determine a first gain factor in terms of useful resources equal to approximately two (2.25 bursts for the second configuration instead of 5.12 bursts for the first configuration), and a second gain factor in terms of useful transfer time equal to approximately four when a geostationary satellite is used.

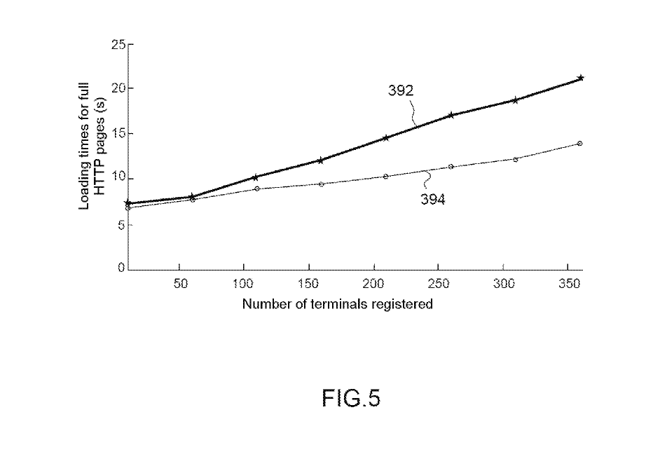

According to FIG. 5, the performance levels in terms of transfer delay for a full page in the format of the http internet protocol relative to the number of terminals registered in the system are compared between a first system using only a random access channel RACH of CRDSA type with congestion control and a second DVD-RCS2 (Digital Video Broadcast-Return Channel 2^{nd} generation) system using demand assigned DA channels when the input traffic is unpredictable sporadic internet traffic.

A first curve 392 represents the trend of the transfer delay for a full http internet page as a function of the number of terminals registered in the case of the use of the first transmission system.

A second curve 394 represents the trend of the transfer delay for a full http internet page as a function of the number of terminals registered in the case of the use of the second transmission system.

FIG. 5 shows that the transfer delay is considerably reduced, by close to half, for a load of 350 terminals, i.e. approximately 40% use of the channel, when a random access channel of CRDSA type is used instead of a demand assigned multiple access DAMA mode channel.

The information items representative of the current transmission resources allocated to the slotted random access channel RACH can be obtained from a first estimated probability of reception of an empty expected burst Pe, or from a pair of estimated probabilities formed by the first measured probability Pe and a second probability of successful reception of a burst Ps, or from a third estimated probability of a burst having undergone a collision Pc.

The probabilities Pe alone, or Pe and Ps, or Pc alone are estimated continuously by the gateway GW, over an observation window of predefined width and from measurements in reception in said observation window of the expected bursts during a step executed before the first step.

The information items representative of the current transmission resources allocated to the random access channel RACH are contained in the set formed by:
the current composition of the random access channel and/or the current list of the classes of terminals authorized to transmit and of the classes of terminals not authorized to transmit; and the estimated probabilities Pe alone, or Pe and Ps, or Pc alone; and
the external input load of the RACH channel estimated from the estimated probability Pe.

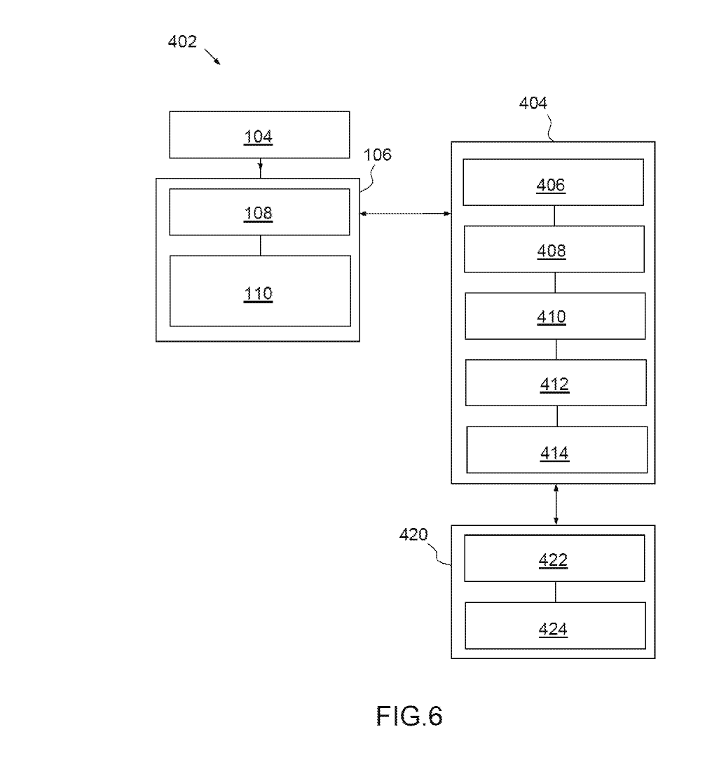

According to FIG. 6 and a particular embodiment 402 of the transmission method 102 described in FIG. 2, the method for the transmission 402 of data packets or packet fragments over a forward link comprises the same first, second, third, fourth steps 104, 106, 108, 110 as those of the method 102 and further comprises, coupled to the second step 106, a method for dynamically adapting 404 the capacity of the random access channel RACH. The method for dynamically adapting 404 the capacity of the RACH channel is described with variants in the patent application entitled “Method for Dynamically Adapting the Capacity of a Random Access Transmission Channel” and filed jointly with the present application.

The dynamic adaptation method 404 comprises a set of subsequent steps.

In a fifth step 406, the value of a desired external load is set as nominal operating point of the RACH channel, the real external load of the channel being equal to the current rate of new terminals coming online transmitting a respective burst of data over the channel.

Then, in a sixth step 408, the connection gateway GW continuously estimates, over an observation window of predefined width and from measurements in reception in said observation window of the expected bursts, a first measured probability of reception of an empty expected burst Pe, or a pair of measured probabilities formed by the first measured probability Pe and a second measured probability of successful reception of a burst Ps, or a third measured probability of a burst having undergone a collision Pc.

In a seventh step 410, using a mathematical model or a simulation, a high first threshold S_{H} and a low second threshold S_{L} of a quantity Gr, monotonically sensitive to the external load of the random access channel RACH, are determined. The upper and lower external loads of the random access channel correspond respectively to the high first threshold or low second threshold, and the sensitive quantity Gr depends on the first probability Pe or on the third probability Pc or on the pair of probabilities (Pe, Ps) and on parameters defining the random access protocol.

Then, in an eighth step 412, the current sensitive quantity is determined as a function of one or both measured probabilities.

Next, a decision-making ninth step 414 is executed by the connection station.

When a crossing of the high first threshold S_{H} by the current sensitive quantity occurs one or more times consecutively moving away from the value of the quantity corresponding to the nominal external load, the connection gateway GW increases the current capacity of the RACH transmission channel by releasing additional communication resources in terms of additional frequencies and by informing the terminals by a return link of the new composition of the transmission channel with increased capacity.

When a crossing of the low second threshold S_{L} occurs by the current sensitive quantity one or more times consecutively moving away from the value of the quantity corresponding to the nominal external load, the connection gateway GW reduces the current capacity of the RACH transmission channel by withdrawing communication resources in terms of frequencies from the transmission resources currently made available and by informing the terminals by the return link of the new composition of the transmission channel with reduced capacity.

The transmission method 402 comprises, on the forward link, data packets or packet fragments and further comprises a flow control method 420, coupled to said method for dynamically adapting 404 the capacity.

The flow control method 420 comprises a set of subsequent steps.

In a tenth step 422, the gateway GW supplies a current list of classes of terminals distinguishing the classes of the terminals authorized to transmit and the classes of the terminals from which transmission is prohibited.

Then, in an eleventh step 424, when the crossing of the high first threshold S_{H} induces a decision to increase the capacity of the channel and a predetermined maximum size of the channel is reached, the gateway triggers an increase in the flow control level by prohibiting a class of terminals authorized to transmit in the current list from transmitting, chosen randomly from the current list, by updating the list of the classes authorized to transmit and by notifying the terminals by the return link of the updated list of the classes authorized to transmit.

When the crossing of the low second threshold S_{L} induces a decision to reduce the capacity of the channel, the gateway triggers a lowering of the flow control level by authorizing a class of terminals prohibited from transmitting in the current list to transmit, chosen randomly from the current list, by updating the list of the classes authorized to transmit and by notifying the terminals by the return link of the updated list of the classes authorized to transmit.

An example of application of the invention is the transmission of traffic of SBD IRIDIUM (Short Burst Data IRIDIUM) type over the random access channel which has to make it possible to considerably reduce the resource used on the return link (“circuit” mode throughout the duration of the transaction) and the message transmission delay.

Generally, the transmission method and system according to the invention described above can be used for all sporadic traffics such as M2M (Mobile to Mobile) and aeronautical communication (aerocom) traffics, and to improve performance levels and the efficiency of use of the resource.

It should be noted that the use of a partial convergence allows for a significant performance gain by requiring only a modification of the terminal software by the addition of a convergence layer. The deployment can also be staged and performed only in the new terminals.

It should be noted that, in addition to the flow control method 420 and in a coupled manner, a congestion control method can be added by being implemented on the terminals.

Advantageously, by using the random access as a priority for the transmission of unpredictable sporadic data traffics (in addition to the signalling), according to the availability of the random access channel RACH, a better efficiency of use of the transmission resource and a better quality of service for this traffic are ensured.

Furthermore, when the resource is not or is no longer available and the demand assigned multiple access can be used to transmit this traffic, the use of a partial convergence requires only modifications on the terminal, and allows for a staged deployment of the total convergence in the system.

A complete integration of the random and DAMA mode accesses is produced in the case of the total convergence where the choice of access is based, in real time, on the availability of the resource on the two channels.

1. A method for transmission over an uplink of data packets or packet fragments from a terminal TE out of a plurality of terminals to a gateway GW,
the data packets or packet fragments being switched between a first random access mode using a random access channel RACH and a second demand assigned multiple access DAMA mode using a demand assigned multiple access DAMA channel, and
the random access channel RACH being shared by the plurality of terminals;
the transmission method comprising the following steps in which:
in a first step, the terminal concerned TE receives, almost in real time from the gateway via a downlink, one or more information items representative of the current transmission resources allocated to the random access channel RACH and to the demand assigned multiple access DAMA mode;
in a second step, the terminal TE routes the data packets or the packet fragments over the random access channel RACH via a random access or a demand assigned multiple access channel via a demand assigned multiple access DAMA according to the size of the packets and their class of service, and information items representative of the current transmission resources allocated to the random access channel RACH and to the demand assigned multiple access DAMA mode,
the information items representative of the current transmission resources allocated being supplied and transmitted to the terminals of the plurality over a return link.

2. The method for transmission over a forward link of data packets or packet fragments according to claim 1, wherein the second step comprises
a third step of implementation of a classification and of a first routing of the packets during which the terminal classifies the packets according to their size and their class of service in terms of quality of service and routes the packets according to this classification either to a uniform first set of queues connected exclusively to the demand assigned multiple access, or to a mixed second set of queues that can be connected separately and selectively in time to one of the two accesses taken from the random access RA and the demand assigned multiple access DAMA.

3. The method for transmission over a forward link of data packets or packet fragments according to claim 1, wherein the terminal prioritizes the routing of the short data packets of low data volume corresponding to sporadic traffic over the random access channel RACH.

4. The method for transmission over a forward link of data packets or packet fragments according to claim 2, wherein the second step comprises
a fourth step consecutive to the third step during which
the packets, delivered at the output of the queues of the mixed second set, are fragmented into one or more packet fragments according to the size of the packets, then
the packets or the packet fragments are scheduled according to respective priorities associated with the packets and determined by the quality of service classes of said packets, then
the packets or the packet fragments are pre-assigned, through an access mode pre-assignment information item, to an access mode, taken from the RA access mode and the DAMA access mode, according to information items representative of the current transmission resources allocated and a predetermined convergence type, taken from a partial convergence and a total convergence, then
the packets or the packet fragments are encapsulated according to an encapsulation protocol which depends on the convergence type, then
the packets or the packet fragments are routed to one of the two accesses taken from the random access RA and the demand assigned multiple access DAMA according to the pre-assigned access mode.

5. The method for transmission over a forward link of data packets or packet fragments according to claim 4, wherein
when the convergence type is a partial convergence,
the encapsulation protocol used is a conventional protocol which does not unambiguously identify the fragments of the packets, and which is transparent to the gateway acting as receiver, and
when the random access RA mode has resources available, the packets or the packet fragments deriving from the mixed second set after fragmentation use the random access RA as a priority; and
when the random access RA mode has no more resources available, the packets or the packet fragments deriving from the mixed second set after fragmentation are redirected to the demand assigned multiple access DAMA mode; and
when a switchover from the RA access mode to the DAMA access mode occurs, the packet or the packet fragments currently being sent to the RA access mode before the switchover are all retransmitted to the demand assigned multiple access DAMA.

6. The method for transmission over a forward link of data packets or packet fragments according to claim 5, wherein
when the convergence type is a partial convergence, a mechanism of ARQ (Automatic Repeat reQuest) type is implemented in the convergence layer implemented in the fourth step.

7. The method for transmission over a forward link of data packets or packet fragments according to claim 3, wherein
when the convergence type is a total convergence,
the encapsulation protocol used is an encapsulation protocol configured to unambiguously identify the content of each fragment of a packet deriving from the mixed second set through an information item identifying the content of each fragment of a packet; and
the access mode of each packet fragment is selected according to the next opportunity for transmission to one of the two accesses, the next opportunity for transmission being the instant closest to the current instant out of the instant of the next transmission over the RACH channel, and the instant resource(s) possibly already assigned to the DAMA access become(s) available.

8. The method for transmission over a forward link of data packets or packet fragments according to claim 7, wherein
when the convergence type is a total convergence, the encapsulation protocol used is:
either a conventional encapsulation protocol modified in terms of the use of a reserve of signalling bits, existing in a field of the frame of the protocol not conventionally used,
or an augmented conventional encapsulation protocol in which a bit field has been added to the field of existing bits of the protocol,
or a new protocol.

9. The method for transmission over a forward link of data packets or packet fragments according to claim 1, wherein
the information items representative of the current transmission resources allocated to the random access channel RACH are obtained from a first estimated probability of reception of an empty expected burst Pₑ, or from a pair of estimated probabilities formed by the measured first probability Pe and a second probability of reception of an empty burst Pₛ, or from a third estimated probability of a burst having undergone a collision P_{c};
the probabilities Pe alone, or Pe and Ps, or Pc alone being estimated continuously by the gateway GW, over an observation window of predefined width and from measurements in reception in said observation window of the expected bursts; and
the third step forming part of the transmission method and being executed before the first step.

10. The method for transmission over a forward link of data packets or packet fragments according to claim 1, wherein
the information items representative of the current transmission resources allocated to the random access channel RACH are contained in the set formed by
the current composition of the random access channel and/or the current list of the classes of terminals authorized to transmit and of the classes of terminals not authorized to transmit; and
the estimated probabilities Pe alone, or Pe and Ps, or Pc alone; and
the external input load of the RACH channel estimated from the estimated probability Pe.

11. The method for transmission over an uplink of data packets or packet fragments according to claim 1, further comprising a method for dynamically adapting the capacity of the random access channel,
the method for dynamically adapting the capacity comprising the following steps:
in a first step, setting the value of a desired external load as nominal operating point of the channel, the real external load of the channel being equal to the current rate of new terminals coming online transmitting a respective burst of data over the channel;
in a second step, continuously estimating, over an observation window of predefined width and from measurements in reception in said observation window of the expected bursts, a first measured probability of reception of an empty expected burst Pe, or a pair of measured probabilities formed by the first measured probability Pe and a second measured probability of successful reception of a burst Ps, or a third measured probability of a burst having undergone a collision Pc;
in a third step, determining, using a mathematical model or a simulation, a high first threshold S_{H} and a low second threshold S_{L} of a quantity Gr monotonically sensitive to the external load of the random access channel, the high and low external loads of the random access channel corresponding respectively to the high first threshold or low second threshold, the sensitive quantity Gr depending on the first probability Pe or on the third probability Pc or on the pair of probabilities and on the type and on parameters defining the random access protocol;
in a fourth step, determining the current sensitive quantity as a function of one or both of the measured probabilities;
in a decision-making fifth step,
when a crossing of the high first threshold by the current sensitive quantity occurs one or more times consecutively moving away from the value of the quantity corresponding to the nominal external load, increasing the current capacity of the transmission channel by releasing additional communication resources in terms of additional frequencies and by informing the terminals by a return link of the new composition of the transmission channel with increased capacity; and/or
when a crossing of the low second threshold by the current sensitive quantity occurs one or more times consecutively moving away from the value of the quantity corresponding to the nominal external load, reducing the current capacity of the transmission channel by withdrawing communication resources in terms of frequencies from the transmission resources currently made available and by informing the terminals by the return link of the new composition of the transmission channel with reduced capacity.

12. The method for transmission over a forward link of data packets or packet fragments according to claim 11, further comprising a flow control method, coupled to said capacity adaptation method and which comprises the following steps in which:
the gateway supplies a current list of classes of terminals distinguishing the classes of the terminals authorized to transmit and the classes of the terminals from which transmission is prohibited, and
when the crossing of the high first threshold S_{H} induces a decision to increase the capacity of the channel and a predetermined maximum size of the channel is reached, the gateway triggers an increase in the flow control level by prohibiting a class of terminals authorized to transmit in the current list from transmitting, chosen randomly from the current list, by updating the list of the classes authorized to transmit and by notifying the terminals by the return link of the updated list of the classes authorized to transmit; and
when the crossing of the low second threshold S_{L} induces a decision to reduce the capacity of the channel, the gateway triggers a lowering of the flow control level by allowing a class of terminals prohibited from transmitting in the current list to transmit, chosen randomly from the current list, by updating the list of the classes authorized to transmit and by notifying the terminals by the return link of the updated list of the classes authorized to transmit.

13. A system for transmitting data packets or packet fragments comprising a plurality of user terminals and a connection gateway GW to a second network,
each terminal being configured to transmit to the gateway GW over an uplink data packets or packet fragments, switched between a first random access mode using a slotted random access channel RACH shared by the plurality of terminals and a second demand assigned multiple access DAMA mode using a demand assigned multiple access DAMA channel;
the transmission system wherein
each terminal is configured to receive, almost in real time from the gateway via a return link, one or more information items representative of the current transmission resources allocated to the random access channel RACH and to the demand assigned multiple access DAMA mode;
each terminal is configured to route the data packets or the packet fragments over the random access channel RACH via a random access or a demand assigned multiple access channel via a demand assigned multiple access DAMA according to the size of the packets and their class of service, and information items representative of the current transmission resources allocated to the random access channel RACH and to the demand assigned multiple access DAMA mode,
the information items representative of the current transmission resources allocated being supplied and transmitted to the terminals of the plurality over a return link.

14. The System for transmitting data packets or packet fragments according to claim 13, wherein
the connection gateway GW is configured to implement the steps consisting in
continuously estimating, over an observation window of predefined width and from measurements in reception in said observation window of the expected bursts, a first measured probability of reception of an empty expected burst Pe, or a pair of measured probabilities formed by the first measured probability Pe and a second measured probability of successful reception of a burst Ps, or a third measured probability of a burst having undergone a collision Pc;
determining a current quantity Gr monotonically sensitive to the external load of the random access channel RACH from the first estimated probability Pe or from the third probability Pc or from the pair of probabilities and from the parameters defining the random access protocol; then
when a crossing of a high first threshold S_{H} by the current quantity occurs one or more times consecutively moving away from the value of the quantity corresponding to the nominal external load, increasing the current capacity of the transmission channel by releasing additional communication resources in terms of additional frequencies and by informing the terminals by a return link of the new composition of the transmission channel with increased capacity; and/or
when a crossing of the low second threshold S_{L} by the current sensitive quantity occurs one or more times consecutively moving away from the value of the quantity corresponding to the nominal external load, reducing the current capacity of the transmission channel by withdrawing communication resources in terms of frequencies from the transmission resources currently made available and by informing the terminals by the return link of the new composition of the transmission channel with reduced capacity.

15. The system for transmitting data packets or packet fragments according to claim 14, wherein
the connection gateway and the terminals are configured to implement a flow control mechanism and a congestion control mechanism through the regular and frequent supply by the connection gateway of a current list of classes of terminals authorized to transmit and of classes of terminals not authorized to transmit.

16. A terminal for transmitting, over an uplink, data packets or packet fragments of data packets or packet fragments, switched between a first random access mode using a random access channel RACH and a second demand assigned multiple access DAMA mode using a demand assigned multiple access DAMA channel,
the terminal comprising:
a first random access RA and a second demand assigned multiple access DAMA respectively comprising a first RA queue connected to a first RA access output terminal and a second DAMA queue connected to a second DAMA output terminal; and
a uniform first set of queues connected exclusively to the second demand assigned multiple access; and
a mixed second set of queues that can be connected separately and selectively in time to one of the two accesses taken from the first random access RA and the second demand assigned multiple access DAMA; and
a unit for classification and first routing of the packets, configured to classify the packets according to their size and their class of service in terms of quality of service, and route the packets according to this classification either to the uniform first set of queues, or to the mixed second set of queues.

17. The transmission terminal according to claim 16, further comprising
a processing and convergence unit connected upstream to a packet input terminal to the first and second sets of queues and upstream to the first and second accesses, and
an RA and DAMA access resource management agent connected between a return link port for receiving signalling signals and the processing and convergence unit,
the access resource management agent being configured to:
monitor the information items representative of the current transmission resources available on the random access channel RACH and on the demand assigned multiple access DAMA mode, and
initiate resource requests according to the filling of the queues of the first and second sets;
the processing and convergence module being configured to:
fragment the packets, delivered at the output of the queues of the mixed second set, into one or more packet fragments according to the size of the packets, then
schedule the packets or the packet fragments according to respective priorities, associated with the packets and determined by the quality of service classes of said packets, then
pre-assign the packets or the packet fragments through an access mode pre-assignment information item, to an access mode, taken from the first RA access and the second DAMA access, according to information items representative of the current transmission resources allocated to the RA and DAMA accesses and according to a predetermined convergence type, taken from a partial convergence and a total convergence, then
encapsulate the packets or the packet fragments according to an encapsulation protocol which depends on the convergence type, then
route the packets or the packet fragments to one of the two accesses taken from the random access RA and the demand assigned multiple access DAMA according to the pre-assigned access mode.

18. A computer program comprising instructions for the implementation of a method for transmission over an uplink of data packets or packet fragments from a terminal TE out of a plurality of terminals to a gateway GW,
the data packets or packet fragments being switched between a first random access mode using a random access channel RACH and a second demand assigned multiple access DAMA mode using a demand assigned multiple access DAMA channel, and
the random access channel RACH being shared by the plurality of terminals;
the transmission method comprising the following steps in which:
in a first step, the terminal concerned TE receives, almost in real time from the gateway via a downlink, one or more information items representative of the current transmission resources allocated to the random access channel RACH and to the demand assigned multiple access DAMA mode;
in a second step, the terminal TE routes the data packets or the packet fragments over the random access channel RACH via a random access or a demand assigned multiple access channel via a demand assigned multiple access DAMA according to the size of the packets and their class of service, and information items representative of the current transmission resources allocated to the random access channel RACH and to the demand assigned multiple access DAMA mode,
the information items representative of the current transmission resources allocated being supplied and transmitted to the terminals of the plurality over a return link, wherein the program is executed by one or more processors of a transmission system defined according to claim 13.
